(19) United States
(12) Patent Application Publication
(10) Pub. No.: US 2023/0098421 A1
(43) Pub. Date: Mar. 30, 2023

(54) METHOD AND APPARATUS OF DYNAMICALLY CONTROLLING APPROXIMATION OF FLOATING-POINT ARITHMETIC OPERATIONS

(71) Applicant: Advanced Micro Devices, Inc., Santa Clara, CA (US)

(72) Inventors: Onur Kayiran, Rochester, NY (US); Mohamed Assem Abd ElMohsen Ibrahim, Santa Clara, CA (US); Shaizeen Aga, Santa Clara, CA (US)

(21) Appl. No.: 17/490,703

(22) Filed: Sep. 30, 2021

(51) Int. Cl. G06F 17/17; G06F 7/483

(52) U.S. Cl. CPC G06F 17/17; G06F 7/483

(57) ABSTRACT

Methods and apparatuses include a processing unit which helps control the speed and computational resources required for arithmetic operations of two numbers in a first format. The control unit of the processing unit approximates the arithmetic operations using a plurality of decomposed numbers in a second format that facilitates faster calculations than the first format, such that performing arithmetic operations using the decomposed numbers is capable of approximating the results of the arithmetic operations of the two numbers in the first format.

### BACKGROUND OF THE DISCLOSURE

Floating-point format is widely used in data processing, such as in the field of machine learning using deep neural network architecture. In some cases, floating-point arithmetic operations with lower numerical precision can be more useful than those with higher numerical precision, such as in training or inferencing neural networks, due to the additional precision possibly offering little to no benefit while being slower and less memory-efficient. As such, there is a need to control the precision of such arithmetic operations, as supported and performed by the hardware of the system, in view of the demand for precision in different data processing applications.

### BRIEF DESCRIPTION OF THE DRAWINGS

The implementations will be more readily understood in view of the following description when accompanied by the below figures, wherein like reference numerals represent like elements, and wherein:

FIG. 1 is an example functional block diagram of a processor system according to embodiments disclosed herein;

FIG. 2 is a comparison of two different data formats that are used in arithmetic operations according to embodiments disclosed herein;

FIG. 3 is an example of a number decomposition used in an approximation of arithmetic operations according to embodiments disclosed herein;

FIG. 4 is an example of an addition operation approximation using number decomposition according to embodiments disclosed herein;

FIG. 5 is an example of a multiplication operation approximation using number decomposition according to embodiments disclosed herein;

FIG. 6 is an example flow diagram of a process implemented in the processor system according to embodiments disclosed herein; and

FIG. 7 is a graphical representation of probability density function for calculated errors resulting from the process according to embodiments disclosed herein.

### DETAILED DESCRIPTION OF IMPLEMENTATIONS

Briefly, systems, apparatuses, and methods are set forth to help control the speed and computational resources required for arithmetic operations of two numbers in a first format, by approximating the arithmetic operations using a plurality of decomposed numbers in a second format that facilitates faster calculations than the first format, such that performing arithmetic operations using the decomposed numbers is capable of approximating the results of the arithmetic operations of the two numbers in the first format.

In some implementations, processing units are disclosed herein, including a memory unit configured to store results of one or more arithmetic operations, a floating-point unit (FPU) configured to perform the one or more arithmetic operations, a control unit operatively coupled with the memory unit and the FPU. The control unit is configured to: perform number decomposition on a first number and a second number of a first floating-point format to represent each of the numbers as a plurality of decomposed numbers of a second floating-point format, the second floating-point format having fewer significand bits than the first floating-point format; cause the FPU to perform the one or more arithmetic operations using the decomposed numbers as dynamically determined based on accuracy demand; and store results of the one or more arithmetic operations in the memory unit in the second floating-point format.

In some embodiments, the control unit of the processing unit is further configured to cause the FPU to approximate a sum of the first number and the second number of the first floating-point format by determining a sum of at least two of the decomposed numbers of the second floating-point format. In some examples, at least two of the decomposed numbers are determined based on significance of exponent values of the decomposed numbers.

In some embodiments, the control unit is further configured to: determine a number of terms to calculate for approximating a product of the first number and the second number of the first floating-point format; cause the FPU to calculate one or more terms according to the determined number of terms, each term comprising either a product of the decomposed numbers of the second floating-point format or a sum of a plurality of products of the decomposed numbers of the second floating-point format; and cause the FPU to approximate a product of the numbers of the first floating-point format using the product or the sum of the products of the decomposed numbers in the one or more arithmetic operations. In some examples, the number of terms is statically or dynamically determined based on the accuracy demand.

In some embodiments, the first floating-point format has a first number of exponent bits, and the second floating-point format has a second number of exponent bits that is different from the first number of exponent bits. In some embodiments, the first floating-point format and the second floating-point format have a same number of exponent bits. In some embodiments, the first floating-point format includes at least three times as many significand bits as the second floating-point format. Each of the numbers of the first floating-point format is decomposable into three numbers of the second floating-point format.

In some embodiments, the results stored in the memory unit are configured to be utilized in machine learning workloads including machine learning training or machine learning inference. In some embodiments, the accuracy demand is automatically and dynamically determined based on the FPU exceeding a threshold number of arithmetic operations to perform. In some embodiments, the accuracy demand is determined based on user input.

In some implementations, processing units are disclosed herein, including a user interface configured to receive user input and a processing unit operatively coupled with the user interface. The processing unit includes a memory unit configured to store results of one or more arithmetic operations, a floating-point unit (FPU) configured to perform the one or more arithmetic operations, and a control unit operatively coupled with the memory unit and the FPU. The control unit is configured to determine accuracy demand for the one or more arithmetic operations based on the user input, perform number decomposition on numbers of a first floating-point format to represent each of the numbers as a plurality of decomposed numbers of a second floating-point format, the second floating-point format having fewer significand bits than the first floating-point format, cause the FPU to perform the one or more arithmetic operations using the decomposed numbers as dynamically determined based on the accuracy demand, and store results of the one or more arithmetic operations in the memory unit in the second floating-point format.

In some embodiments, the computing system further includes one or more remote servers wirelessly coupled with the processing unit via a wireless network. The servers are configured to store the results of the arithmetic operations to be utilized in machine learning workloads including machine learning training or machine learning inference. In some embodiments, the control unit is further configured to cause the FPU to approximate a sum of the first number and the second number of the first floating-point format by determining a sum of at least two of the decomposed numbers of the second floating-point format. In some examples, at least two of the decomposed numbers are determined based on significance of exponent values of the decomposed numbers.

In some embodiments, the control unit is configured to determine a number of terms to calculate for approximating a product of the first number and the second number of the first floating-point format, cause the FPU to calculate one or more terms according to the determined number of terms, each term comprising either a product of the decomposed numbers of the second floating-point format or a sum of a plurality of products of the decomposed numbers of the second floating-point format, and cause the FPU to approximate a product of the numbers of the first floating-point format using the product or the sum of the products of the decomposed numbers in the one or more arithmetic operations. In some examples, the number of terms is statically or dynamically determined based on the accuracy demand.

In some embodiments, the first floating-point format has a first number of exponent bits, and the second floating-point format has a second number of exponent bits that is different from the first number of exponent bits. In some embodiments, the first floating-point format and the second floating-point format have a same number of exponent bits. In some embodiments, the first floating-point format includes at least three times as many significand bits as the second floating-point format, wherein each of the numbers of the first floating-point format is decomposable into three numbers of the second floating-point format.

In some implementations, methods of floating-point arithmetic operation approximation are disclosed herein. The method includes: performing, by a controller of a processing unit, number decomposition on numbers of a first floating-point format to represent each of the numbers as a plurality of decomposed numbers of a second floating-point format, the second floating-point format having fewer significand bits than the first floating-point format; performing one or more arithmetic operations using the decomposed numbers as dynamically determined based on accuracy demand; and storing results of the one or more arithmetic operations in a memory unit in the second floating-point format.

In some embodiments, the method further includes approximating a sum of the first number and the second number of the first floating-point format by determining a sum of at least two of the decomposed numbers of the second floating-point format. In some examples, at least two of the decomposed numbers are determined based on significance of exponent values of the decomposed numbers. In some embodiments, the method includes determining a number of terms to calculate for approximating a product of the first number and the second number of the first floating-point format, calculating one or more terms according to the determined number of terms, each term comprising either a product of the decomposed numbers of the second floating-point format or a sum of a plurality of products of the decomposed numbers of the second floating-point format, and approximating a product of the numbers of the first floating-point format using the product or the sum of the products of the decomposed numbers in the one or more arithmetic operations. In some examples, the number of terms is statically or dynamically determined based on the accuracy demand.

In the following description, numerous specific details are set forth to provide a thorough understanding of the methods and mechanisms presented herein. However, one having ordinary skill in the art should recognize that the various embodiments can be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements can be exaggerated relative to other elements.

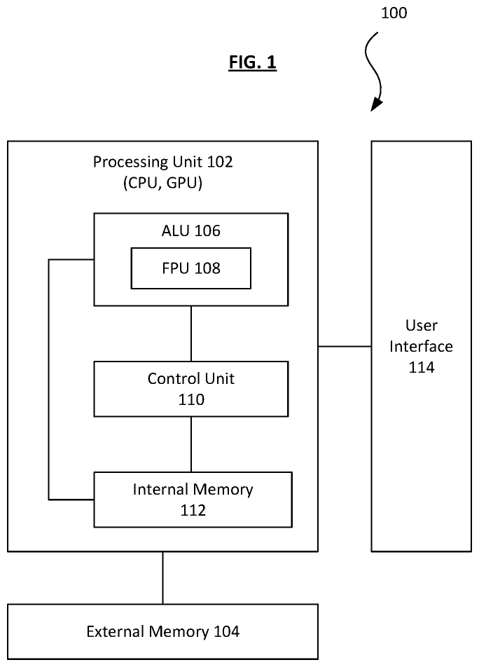

FIG. 1 illustrates a high-level view of an exemplary processor system 100 according to embodiments disclosed herein. The system 100 includes a processing unit 102 and, in some examples, may include an external memory unit 104 operatively coupled therewith. The processing unit 102 includes an arithmetic logic unit (ALU) 106 which includes a floating point unit (FPU) 108. In some examples, there may be a plurality of FPUs 108 within the processing unit 102 such that one or more of the FPU 108 are capable of performing arithmetic operations in a different floating-point format from the another FPU 108. The processing unit 102 also includes a control unit 110 and an internal memory unit 112, such that the ALU 106, the control unit 110, and the internal memory unit 112 are operatively coupled together via data communication means such as data bus and data channels, for example.

In some examples, the processor system 100 includes a user interface 114 including means to receive user input via the interface 114, for example a touchscreen, a display with a keyboard, or any other suitable means. In some examples, the external memory unit 104 and/or the user interface 114 may be operatively coupled with the processing unit 102 via wires or wirelessly, or they may be implemented with the processing unit 102. For larger-precision arithmetic operations, software-based solutions such as arbitrary-precision arithmetic including “bignum arithmetic” or “bigfloat” libraries, as well as floating-point emulation library for fixed-point processors, may be implemented. However, such software solutions would operate at a considerably slower speed than hardware-supported solutions, which are the solutions supported by the ALUs of the processor system, as disclosed herein.

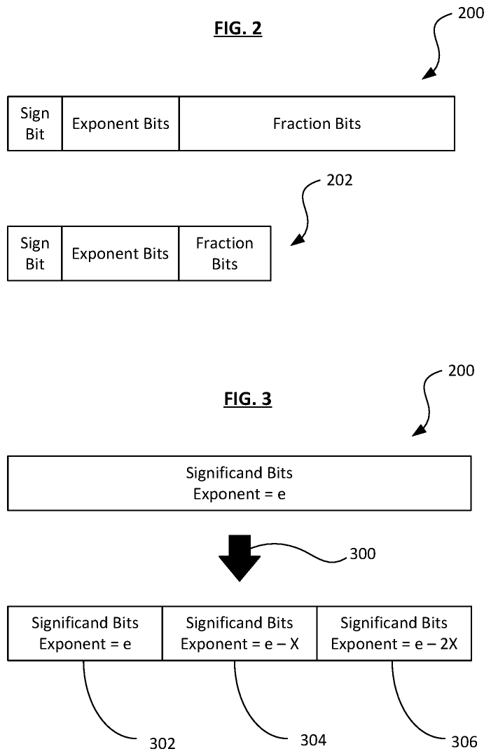

FIG. 2 shows an example of the two different floating-point formats which may be implemented in the floating-point arithmetic operation approximation methods disclosed herein. A first floating-point format 200 includes a sign bit, a first number of exponent bits, and a first number of fraction bits. A second floating-point format 202 includes a sign bit, a second number of exponent bits, and a second number of fraction bits that is fewer than the number of fraction bits in the first floating-point format 200. In some examples, the number of exponent bits in each of the formats 200 and 202 may be the same. In some examples, one format may have more exponent bits than the other format. The second floating-point format 202 is used for number decomposition of the numbers in the first floating-point format 200.

In some examples, the first format 200 is a single-precision floating-point format FP32 or float32, and the second format 202 is the “Brain Floating Point” format BF16 or bfloat16 which is a truncated 16-bit version of the FP32 format. As such, in such cases, the number of exponent bits in both formats is the same, and the BF16 format has fewer fraction bits (7 bits) than the FP32 format (23 bits). In some examples, other suitable formats may be used, for example a double-precision floating-point format FP64 or float64 for the first format. Other formats which may be used for either the first format 200 or second format 202 may include, but are not limited to, FP64, FP16, BF32, BFB, etc., so long as there is sufficient hardware support with regard the exponent bits if the first format 200 and the second format 202 used for decomposition have different numbers of exponent bits. The “floating point” formats as disclosed herein follow a technical standard for floating-point arithmetic such as the IEEE Standard for Floating-Point Arithmetic (IEEE 754).

In some examples, the first format 200 and the second format 202 differ in that the first format 200 includes at least three times as many significand bits as the second format 202. The number of significand bits is defined as the number of fraction bits plus an additional hidden bit which is the leftmost bit of the significand indicating whether the number is normalized. As such, each of the numbers of the first format 200 is decomposable into three numbers of the second format 202. This may be applicable if FP32 is the first format 200 (with 24 significand bits) and BF16 is the second format 202 (with 8 significand bits), for example. In some examples, the first format 200 includes at least six times as many significand bits as the second format 202 such that each number of the first format 200 is decomposable into six or more numbers of the second format 202. This may be applicable if FP64 is the first format 200 (with 52 significand bits) and BF16 is the second format 202 (with 8 significand bits), for example.

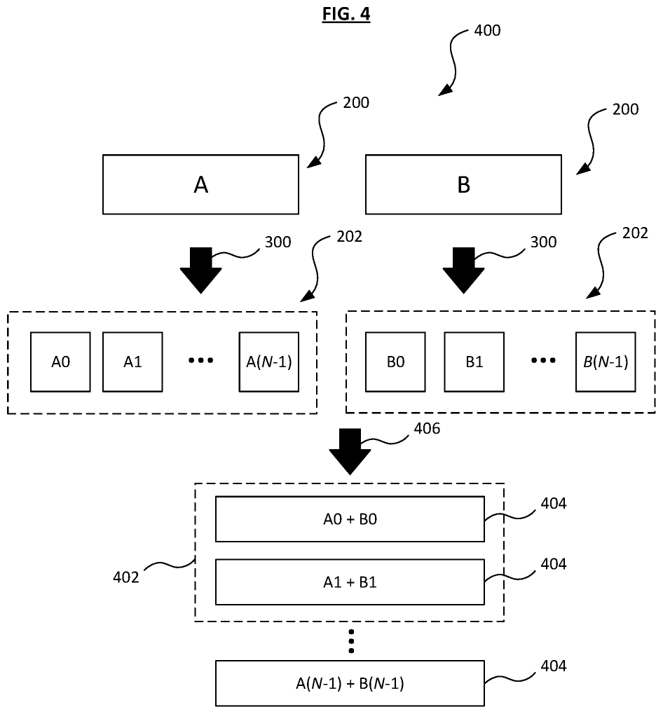

FIG. 3 illustrates how a number decomposition may be performed to decompose a number in the first format 200 into a plurality of decomposed numbers in the second format 202. Specifically, the number in the first format 200 which has a first number of significand bits and an exponent value (e) defined by the exponent bits is decomposed via number decomposition 300 into a plurality of decomposed numbers 302, 304, and 306 in the second format 202 each having a second number of significand bits that is fewer then the first number of significand bits in the first format 200. In some examples, the numbers in the first format 200 and the decomposed numbers 302, 304, and 306 in the second format 202 are normalized; in some examples, the decomposed numbers 302, 304, and 306 are not normalized.

The first decomposed number 302 has a first exponent value (e) that is the same as the exponent value of the number in the first format 200, the second number 304 has a second exponent value that is smaller than the first exponent value (e.g., the second exponent value may be represented as “e— X” where X is an increment of any suitable number of bits), and the third number 306 has a third exponent value that is smaller than the second exponent value (e.g., the third exponent value may be represented as “e— 2X” indicating two increments “2X” smaller than the first exponent value “e”). Although only three decomposed numbers are shown, there may be fewer or greater numbers of decomposed numbers according to some examples. If one or more of the aforementioned exponent values is less than zero, i.e. negative, the negative exponent values may be handled separately. In some examples, the negative exponents may be assumed to be equal to zero and thus discarded from calculation. In some examples, the exponent values are denormalized such that, if the resulting exponent value was −N, the final exponent value would be equal to zero, and the significand is thus shifted to the right by N bits.

In some examples where the first format 200 is FP32 and the second format 202 is BF16, the first format 200 has 24 significand bits (23 fraction bits and 1 hidden bit), and the second format 202 has 8 significand bits (7 fraction bits and 1 hidden bit). A number (A) in FP32 format can be represented as follows: A_fp32=(−1)^{s}*(1+f)*2^{e-127} where s is defined by the sign bit (0 or 1), f is defined by the fraction bits, and e is defined by the exponent bits.

The value for “X” is 8, equal to the number of significand bits in the second format 202. The first decomposed number 302 has the greatest significance to the approximation because its exponent value is the same as that of the original number in the first format 200. Therefore, a number (A) in BF16 format can also be represented using the same expression as in A_fp32, that is, A_bf16=(−1)^{s}*(1+f)*2^{e-127}, where the difference between A_bf16 and A_fp32 is in the range of values that can be represented by the fraction bits f.

In such cases, the number (A) in the FP32 format can be represented by the sum of three numbers (A0, A1, and A2, where A0 is the first decomposed number 302, A1 is the second decomposed number 304, and A2 is the third decomposed number 306) in the BF16 format, that is, A_fp32 is represented by the following sum: A0_bf16+A1_bf16+A2_bf16. Therefore, a single addition operation of two numbers (A and B) in the FP32 format can be represented using three addition operations with six numbers (A0, A1, A2, B0, B1, and B2, where B0 is the first decomposed number 302, B1 is the second decomposed number 304, and B2 is the third decomposed number 306 for the second number B) in the BF16 format. That is, A_fp32+B_fp32 is represented by the following sum: (A0_bf16+B0_bf16)+(A1_bf16+B1_bf16)+(A2_bf16+B2_bf16), where adding two corresponding numbers with the same exponent value corresponds to an addition operation. The result of the arithmetic operation can be stored in the memory unit as three decomposed numbers in the BF16 format, that is, each of the aforementioned sums in parentheses (A0_bf16+B0_bf16, A1_bf16+B1_bf16, and A2_bf16+B2_bf16) is stored as a number in the BF16 format, instead of being recomposed in a number in the FP32 format using digital circuits such as barrel shifters, for example. In some examples, if there is a sufficiently large difference between the exponent values of the two numbers to be added, the processor system may determine not to perform the addition operation, as the smaller number will essentially be a null element. The difference between the exponent values may be any suitable number greater than 3, 4, or 5, for example.

Multiplication operation of two FP32-format numbers can be represented using the six BF16 numbers mentioned above, with thirteen total arithmetic operations, i.e. nine multiplication operations and four addition operations, in BF16 format. That is, A_fp32*B_fp32 is represented by the following sum of products: (A0_bf16*B0_bf16)+(A0_bf16*B1_bf16+A1_bf16*B0_bf16)+(A0_bf16*B2_bf16+A1_bf16*B1_bf16+A2_bf16*B0_bf16)+(A1_bf16*B2_bf16+A2_bf16*B1_bf16)+(A2_bf16*B2_bf16). Again, each product (A0_bf16*B0_bf16 or A2_bf16*B2_bf16) or sum of products (A0_bf16*B1_bf16+A1_bf16*B0_bf16, A0 bf16*B2_bf16+A1_bf16*B1_bf16+A2_bf16*B0_bf16, or A1_bf16*B2_bf16+A2_bf16*B1_bf16) in parentheses may be stored in the memory unit as a separate number in the BF16 format.

The results of the arithmetic operations may be stored in the BF16 format (i.e., stored as the decomposed number) due to any number of reasons. In some examples, the processor system may lack an FP32 ALU support that is necessary to recompose the number into the FP32 format. In some examples, the processor system may have hardware support for FP32-format additions, but not FP32-format multiplications, in which case the output of the multiplication approximation performed using the BF16 format can be recomposed into a number of the FP32 format. In some examples, the process of recomposing the number from the BF16 format to the FP32 format may require additional computing time or resources which may not be required. For example, in some implementations such as machine learning, the speed of computing the arithmetic operation as well as the reduction in computing power or resources necessary for the arithmetic operation may outweigh the benefit of the precision or accuracy resulting from using FP32-format numbers instead of the BF16-format approximations.

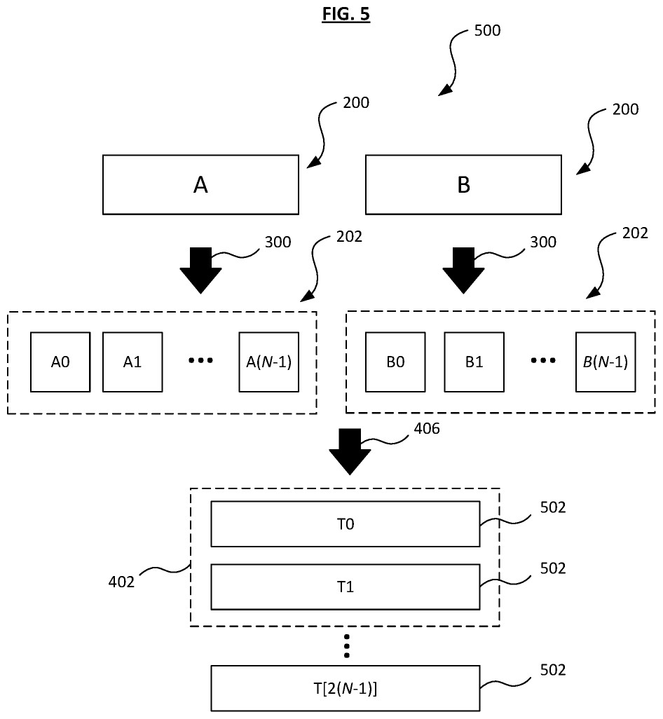

Approximations of floating-point arithmetic operations are performed as follows, where two types of arithmetic operations are considered: addition and multiplication. FIG. 4 is a graphical representation of an approximation method 400 for an addition operation. The precision of the approximation can be controlled based on the number of addition operations of the second format 202 that is performed.

The numbers A and B in the first floating-point format 200 are decomposed into two or more decomposed numbers in the second floating-point format 202 using number decomposition 300. For example, the number A is decomposed into N numbers: A0, A1, . . . , and A(N−1) where N is determined by the difference between the number of significand bits in the first format 200 and the second format 202. In some examples,

$$N = ( \frac{X}{Y} ) ,$$

where X is the number of significand bits in the first format 200 and Y is the number of significand bits in the second format 202. The number B is similarly decomposed into the same number of decomposed numbers N, that is, B0 through B(N−1), as the number A.

Before any addition operation may be performed on the decomposed numbers in the second format 202, the control unit of the processing unit receives or determines an accuracy demand 402 for the approximation of the arithmetic operation and determines the number of operations to be performed in the second format 202 based on the accuracy demand 402. The accuracy demand 402 causes the control unit to determine which one or more of the possible addition operations 404 in the second format 202 may be performed. In the example shown, the accuracy demand 402 requires only the first two operations 404 to be performed, and all subsequent operations are disregarded in order to reduce the computation time and resources used. Thereafter, arithmetic operations 406 (which in this case only include addition operations) are performed only based on the selected operations 404 based on the accuracy demand 402.

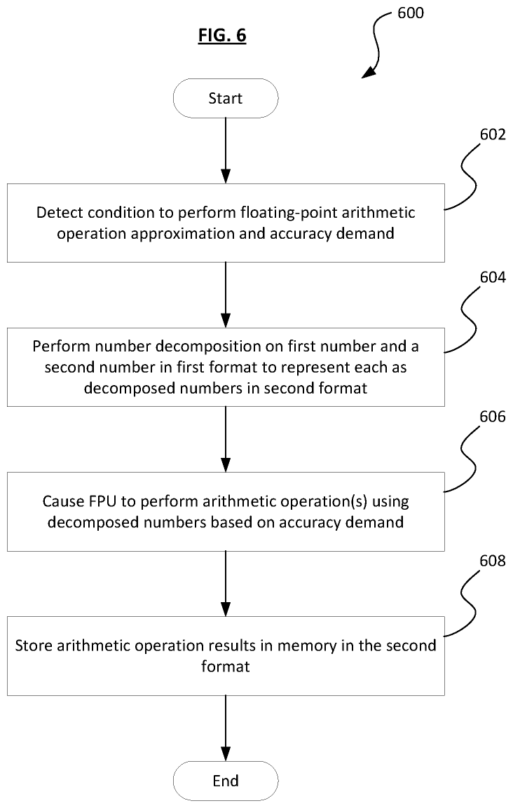

FIG. 5 is a graphical representation of an approximation method 500 for a multiplication operation. The precision of the approximation can be controlled based on the number of addition operations and multiplication operations of the second format 202 that is performed.

Similar to the method 400 for approximating an addition operation, the approximation method 500 for a multiplication operation also decomposes each of the two numbers A and B to be multiplied into two or more decomposed numbers in the second floating-point format 202 using number decomposition 300. However, in this method 500, instead of determining which of the addition operations 404 to perform, the accuracy demand 402 determines the number of terms 502, or T0, T1, . . . , and T[2(N−1)] to be calculated. Each term 502, as used herein, is either a product of two numbers in the second format 202 or a sum of two or more products of numbers in the second format 202, where each product in the same term has similar exponents. In the example as shown, only the first two terms TO and T1 are selected based on the accuracy demand 402, in response to which the arithmetic operations 406 are performed accordingly to determine the values of T0 and T1.

As an illustrative example, the method 500 is further explained using FP32 as the first format 200 and BF16 as the second format 202. In this case, as previously explained, three BF16-format numbers may be used to represent a single FP32-format number. Therefore, the product of two FP32-format numbers is represented using nine multiplication operations and four addition operations. The individual terms 502 (when N=3) may be expressed as:

T0=A0_bf16*B0_bf16 (Equation 1)

T1=A0_bf16*B1_bf16+A1_bf16*B0_bf16 (Equation 2)

T2=A0bf16*B2_bf16+A1_bf16*B1_bf16+A2_bf16*B0_bf16 (Equation 3)

T3=A1_bf16*B2_bf16+A2_bf16*B1_bf16 (Equation 4)

T4=A2_bf16*B2_bf16 (Equation 5)

For example, TO would be equivalent to casting the FP32 numbers into BF16 and performing multiplication on said BF16 numbers. T0+T1 would provide an additional level of precision, which would require three multiply-accumulate operations. T0+T1+T2 would provide yet additional level of precision, but would require six multiply-accumulate operations and an additional add operation, requiring a total of seven operations. Additional operations may be included to process high and low bits of the product separately, as explained below. In view of the above, calculating and including additional terms would improve the accuracy of the results but would also lead to lower performance and more memory footprint due to each term being stored separately in the memory.

In some examples, there is an additional consideration with approximation of multiplication operations regarding the high and low bits of the product (two N-bit numbers yielding a 2*N-bit product) and the lower N bits also being considered during calculation. For example, if the lower bits of the TO product from Equation 1 are rounded and discarded, it may cause further rounding errors to the sum of products in T1 from Equation 2. For a more accurate operation, the lower bits of the TO product may be added to the high bits of the T1 result. Even with such additional consideration, the sum of T0+T1 can still be calculated using only three multiply-accumulate operations. The ALU would accordingly be capable of supporting this configuration using the lower bits to be used in the next computational step.

It is to be understood that the number of terms 502, i.e. 2N−1, may vary depending on the different types of floating-point formats that are used as the first format 200 and the second format 202, that is, by how many numbers (i.e., N) in the second format 202 it is required to represent a number in the first format 200.

For example, if a number in the first format 200 may be decomposed into four numbers (N=4) in the second format 202, there would be a total of seven terms 502, that is, from T0 to T6, where T6=A3_bf16*B3_bf16. If the number in the first format 200 may be decomposed into five numbers (N=5) in the second format 202, there would be a total of nine terms 502, that is, from T0 to T8, where T8=A4_bf16*B4_bf16. The number of arithmetic operations required to calculate the terms 502 would also vary accordingly. The accuracy demand 402, therefore, can select as few as just the first term TO (when the accuracy demand is the lowest) or any number of additional terms (when the accuracy demand is higher, i.e. additional level of precision is required). The user, therefore, has the capability of balancing performance and accuracy by determining how many of the terms, starting with TO, should be calculated.

The accuracy demand 402 causes the control unit to select one or more of the addition operations 404 or terms 502 in the second format 202 having the greatest significance with respect to the original calculation in the first format 200, that is, having the same or similar exponent value as the result of the arithmetic operation performed in the first format 200, for example.

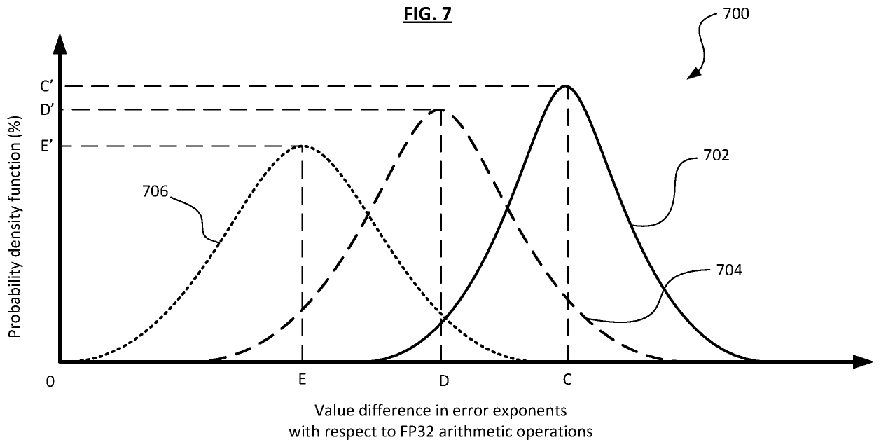

FIG. 6 shows a flow diagram of a method 600 of processing arithmetic approximation of floating-point numbers as disclosed. In step 602, the processing unit determines or detects a condition to perform floating-point arithmetic operation approximation, as well as an accuracy demand for the approximation.

In some examples, the condition may be defined as an input from a user, for example via the user interface, to perform approximation of floating-point arithmetic operations, where the user also defines the accuracy demand for the approximation. In some examples, the accuracy demand may correspond to the error tolerance of the workload, such as that of the machine learning architecture. In some examples, the condition and accuracy demand may be statically specified by the user, i.e. the user may specify the amount of arithmetic operations to be performed beforehand, such as via the API or an instruction that passes along the level of performance and/or accuracy tradeoffs of using such approximation.

In some examples, a computer program code may be implemented by the processing unit to program a control register near the ALU to specify the amount of arithmetic operations to be performed and the number of operations can be increased or decreased via a dynamic scheme based on the required accuracy or error. For example, if the ALUs of the first format (e.g., first floating-point format 200) are busy (e.g., the number of operations to be performed by the ALUs in a given amount of time exceeds a given threshold), a runtime mechanism may decide to perform the computation using ALUs of the second format 202 to improve the ALU utilization.

In some examples, the user can specify levels of required accuracy for different computations, and the runtime schedules the computation with higher accuracy requirements to the ALUs of the first format 200 and others to the ALUs of the second format 202; the number of operations performed by the ALU of the second format 202 for controlling the performance and/or accuracy trade-off is modified by the hardware and is dynamically based on the utilization of both types of ALUs. Furthermore, the user or system may specify what happens to data structures with different accuracy levels. For example, the computation may be performed based on the data structure with higher accuracy requirements.

Furthermore, in some examples, if the ALUs are heavily utilized, the system or the hardware may determine to reduce the accuracy demand in order to facilitate faster computation. In some examples, the instructions for an add or multiply operation may include enable/disable bit(s) indicating whether a predetermined feature (e.g., accuracy requirement) is to be enabled or disabled depending on the value of the enable/disable bit(s). As such, when the enable/disable bit(s) indicate that the accuracy requirement is enabled, the system may set the accuracy demand at a predetermined level of accuracy demand in order to fulfill the accuracy requirement, where the predetermined level of accuracy has a higher accuracy than when the accuracy requirement is disabled. In some examples, if there is a sufficiently large difference between the exponent values of the two numbers to be added, the processor system may determine not to perform the add operation, as the smaller number will essentially be a null element. The difference between the exponent values may be any suitable number greater than 3, 4, or 5, for example. In some examples, the user may specify the data structures or portions of code to enable/disable and/or specify the level of accuracy demand.

In step 604, the number decomposition is performed on the first number and the second number in the first format such that each number is represented as a set of decomposed numbers in the second format. In step 606, the FPU is caused to perform at least one arithmetic operation using the decomposed numbers based on the accuracy demand, as determined using any one of the methods described above.

In some implementations, an additional step 608 may be further implemented, in which the results of the arithmetic operation(s) are stored in the memory in the second format, that is, without converting the results back to the first format. In some examples, subsequent calculations are performed using the stored numbers in the second format. For example, if there is sufficient hardware support for FP32-format additions but not for FP32-format multiplications in the processor, the ALU may be used to accumulate the plurality of calculation results (that is, results of the approximation of the FP32-format multiplication using BF16-format arithmetic operations) into a single FP32-format number (first format) to be stored in the memory, therefore not requiring step 608 to be implemented. However, if there is no hardware support for FP32-format additions in the processor, implementation of step 608 may be required so the calculation results can be stored as BF16-format numbers (second format) in the memory.

FIG. 7 shows a generalized error-analysis graph 700 comparing the probability density functions of the results of multiplication approximation using methods of various accuracy as disclosed herein. The error analysis may be performed as follows. First, numbers of the first format 200 (which is FP32 in this example) are generated, and the product of two FP32 numbers are calculated using a FP32 multiplication operation, i.e. without decomposition. Because floating-point arithmetic calculations inherently include rounding errors, the error for the product is determined and named “err_fp32.” Next, the FP32 numbers are decomposed into a total of six numbers of the second format 202 (which is BP16 in this example), and approximation of the FP32 multiplication operation is conducted based on three different accuracy demands: the first accuracy demand being the lowest and uses only the first term T0, the second accuracy demand being higher and uses T0+T1, and the third accuracy demand being even higher and uses T0+T1+T2. The rounding errors of the approximations with the first, second, and third accuracy demands are calculated and named “err_1bf16”, “err_3bf16”, and “err_7bf16”, respectively, where the “1”, “3”, and “7” in the names are derived from the number of BF16 operations that are necessary for the respective approximation. Finally, the exponent of each of the BF16 errors is compared with the exponent of the FP32 error. If the results are identical, the exponent difference in these errors would be zero. In the graph 700, the exponent differences that are obtained using this method are plotted along the x-axis.

In the graph 700, a solid-line curve 702 represents a probability distribution of the difference between err_1bf16 and err_fp32, a broken-line curve 704 represents a probability distribution of the difference between err_3bf16 and err_fp32, and a dotted-line curve 706 represents a probability distribution of the difference between err_7bf16 and err_fp32. It is to be understood that this is an illustrative representation of a general trend which may be observed in some implementations of the approximation method disclosed herein, and does not guarantee that the results would look identical to what is depicted. For example, in some implementations, the probability distribution may be spread apart over a wider range than is shown, or there may be outliers in the data. As such, the graph 700 is used solely to illustrate some of the benefits and advantages of using the approximation methods as disclosed, according to some examples.

The curve 702 is generally located to the right of the curves 704 and 706 along the x-axis, indicating that there is greater difference between err_1bf16 and err_fp32 than between err_fp32 and the other two errors. The highest concentrations of errors err_1bf16, err_3bf16, and err_7bf16 are observed at C, D, and E, respectively, where C≥D≥E in some examples, indicating that the errors are reduced with respect to err_fp32 as the number of terms increases. The relationship between corresponding percentage values C′, D′, and E′ of the point of highest concentrations C, D, and E, respectively, may also be shown as C′≥D′≥E′ in some examples, indicating that the errors are more evenly distributed as the number of terms increases. As such, graph 700 generally illustrates that using more terms (which also means using more operations) can increase the accuracy of the approximation.

Advantages of the methods disclosed herein include the ability to perform arithmetic operations of a first floating-point format 200 with reasonable accuracy even in situations or systems where the ALU does not support the first floating-point format 200. Because the area complexity required to implement an ALU in a processing unit increases with the square of the size of the significand, an ALU capable of supporting the first floating-point format 200 may be much more complex than another ALU capable of supporting only the second floating-point format 202 with fewer significands, for the same number of operands or inputs. For ALUs with hardware design constraints (including but not limited to area, physical design, etc.), decreasing the area complexity would be a significant advantage. Further advantages include the flexibility afforded by the disclosed methods, where depending on the error tolerance of the application, the user can specify the accuracy of the operation, which may lead to improved performance.

As mentioned herein, the processing unit 102 can be any type of processor such as a central processing unit (CPU) or a graphics processing unit (GPU). For example, the processing unit 102 can be implemented as an x86 processor with x86 64-bit instruction set architecture and is used in desktops, laptops, servers, and superscalar computers; an Advanced Reduced Instruction Set Computer (RISC) Machine (ARM) processor that is used in mobile phones or digital media players; or a digital signal processor (DSP) that is useful in the processing and implementation of algorithms related to digital signals, such as voice data and communication signals, and microcontrollers that are useful in consumer applications, such as printers and copy machines.

The control unit 110 can include, but are not limited to, modules to perform address generation and load and store units that perform address calculations for memory addresses and the loading and storing of data from memory. The operations performed by the processing unit 102 enable the running of computer applications. The processing unit 102 and the control unit 110 use the ALU 106 to perform the approximation methods disclosed herein in order to emulate another ALU that is capable of performing larger precision arithmetic operations than what the ALU 106 is designed for. That is, in some examples, the approximation facilitates increasing the accuracy of quad-precision arithmetic operations performed on dual-precision ALUs instead of designing quad-precision ALUs to perform such arithmetic operations, since doing so may be more costly and/or more difficult to implement in limited spacing.

The approximation methods disclosed herein may be implemented in several scenarios or situations where area or spacing constraints prevent higher-precision ALUs to be employed and/or where a more dynamic control over the operand decision such as accuracy and performance is desired. Examples of such scenarios and situations include in- or near-memory ALUs, which may be lower-precision ALUs due to the area constrains, and using lower-precision ALUs in some situations may prevent the offload of data-intensive computations to the memory, which may require higher precision calculations. Also, the approximation methods may be useful in lower-power-embedded processors which have smaller area constrains. Other scenarios or situations may include when the user or the control unit dynamically chooses lower-precision computation units to perform certain computations when higher-precision computation units are unavailable or need to be reserved for other computations or other concurrent applications.

Furthermore, some machine learning workloads may utilize low-precision arithmetic calculations during training and/or inference. For example, in some cases, half-precision floating-point may be sufficient for such purposes. Therefore, low-precision ALUs may be favored for such workloads, and the approximation methods may be beneficial in facilitating the low-precision ALUs of the processor to approximate high-precision arithmetic computations, when necessary, using low-precision arithmetic computations which can be performed at a faster speed and a lower cost than the low-precision ALUs.

Although features and elements are described above in particular combinations, each feature or element can be used alone without the other features and elements or in various combinations with or without other features and elements. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be mask works that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

In the preceding detailed description of the various embodiments, reference has been made to the accompanying drawings which form a part thereof, and in which is shown by way of illustration specific preferred embodiments in which the invention can be practiced. These embodiments are described in sufficient detail to enable those skilled in the art to practice the invention, and it is to be understood that other embodiments can be utilized, and that logical, mechanical and electrical changes can be made without departing from the scope of the invention. To avoid detail not necessary to enable those skilled in the art to practice the invention, the description can omit certain information known to those skilled in the art. Furthermore, many other varied embodiments that incorporate the teachings of the disclosure can be easily constructed by those skilled in the art. Accordingly, the present invention is not intended to be limited to the specific form set forth herein, but on the contrary, it is intended to cover such alternatives, modifications, and equivalents, as can be reasonably included within the scope of the invention. The preceding detailed description is, therefore, not to be taken in a limiting sense, and the scope of the present invention is defined only by the appended claims. The above detailed description of the embodiments and the examples described therein have been presented for the purposes of illustration and description only and not by limitation. For example, the operations described are done in any suitable order or manner. It is therefore contemplated that the present invention covers any and all modifications, variations or equivalents that fall within the scope of the basic underlying principles disclosed above and claimed herein.

The above detailed description and the examples described therein have been presented for the purposes of illustration and description only and not for limitation.

What is claimed is:

1. A processing unit comprising:
a memory unit configured to store results of one or more arithmetic operations;
a floating-point unit (FPU) configured to perform the one or more arithmetic operations; and
a control unit operatively coupled with the memory unit and the FPU, the control unit configured to:
perform number decomposition on a first number and a second number of a first floating-point format to represent each of the numbers as a plurality of decomposed numbers of a second floating-point format, the second floating-point format having fewer significand bits than the first floating-point format,
cause the FPU to perform the one or more arithmetic operations using the decomposed numbers as dynamically determined based on accuracy demand, and
store results of the one or more arithmetic operations in the memory unit in the second floating-point format.

2. The processing unit of claim 1, the control unit further configured to:
cause the FPU to approximate a sum of the first number and the second number of the first floating-point format by determining a sum of at least two of the decomposed numbers of the second floating-point format.

3. The processing unit of claim 2, wherein the at least two of the decomposed numbers are determined based on significance of exponent values of the decomposed numbers.

4. The processing unit of claim 1, the control unit further configured to:
determine a number of terms to calculate for approximating a product of the first number and the second number of the first floating-point format,
cause the FPU to calculate one or more terms according to the determined number of terms, each term comprising either a product of the decomposed numbers of the second floating-point format or a sum of a plurality of products of the decomposed numbers of the second floating-point format, and
cause the FPU to approximate a product of the numbers of the first floating-point format using the product or the sum of the products of the decomposed numbers in the one or more arithmetic operations.

5. The processing unit of claim 4, wherein the number of terms is statically or dynamically determined based on the accuracy demand.

6. The processing unit of claim 1, wherein the first floating-point format has a first number of exponent bits, and the second floating-point format has a second number of exponent bits that is different from the first number of exponent bits.

7. The processing unit of claim 1, wherein the first floating-point format and the second floating-point format have a same number of exponent bits.

8. The processing unit of claim 1, wherein the first floating-point format includes at least three times as many significand bits as the second floating-point format, wherein each of the numbers of the first floating-point format is decomposable into three numbers of the second floating-point format.

9. The processing unit of claim 1, wherein the results stored in the memory unit are configured to be utilized in machine learning workloads including machine learning training or machine learning inference.

10. The processing unit of claim 1, wherein the accuracy demand is automatically and dynamically determined based on the FPU exceeding a threshold number of arithmetic operations to perform.

11. The processing unit of claim 1, wherein the accuracy demand is determined based on user input.

12. A computing system comprising:
a user interface configured to receive user input; and
a processing unit operatively coupled with the user interface, the processing unit comprising:
a memory unit configured to store results of one or more arithmetic operations;
a floating-point unit (FPU) configured to perform the one or more arithmetic operations; and
a control unit operatively coupled with the memory unit and the FPU, the control unit configured to:
determine accuracy demand for the one or more arithmetic operations based on the user input,
perform number decomposition on numbers of a first floating-point format to represent each of the numbers as a plurality of decomposed numbers of a second floating-point format, the second floating-point format having fewer significand bits than the first floating-point format,
cause the FPU to perform the one or more arithmetic operations using the decomposed numbers as dynamically determined based on the accuracy demand, and
store results of the one or more arithmetic operations in the memory unit in the second floating-point format.

13. The computing system of claim 12, further comprising:
one or more remote servers wirelessly coupled with the processing unit via a wireless network, the servers configured to store the results of the arithmetic operations to be utilized in machine learning workloads including machine learning training or machine learning inference.

14. The computing system of claim 12, the control unit further configured to:
cause the FPU to approximate a sum of the first number and the second number of the first floating-point format by determining a sum of at least two of the decomposed numbers of the second floating-point format.

15. The computing system of claim 14, wherein the at least two of the decomposed numbers are determined based on significance of exponent values of the decomposed numbers.

16. The computing system of claim 12, the control unit further configured to:
determine a number of terms to calculate for approximating a product of the first number and the second number of the first floating-point format,
cause the FPU to calculate one or more terms according to the determined number of terms, each term comprising either a product of the decomposed numbers of the second floating-point format or a sum of a plurality of products of the decomposed numbers of the second floating-point format, and
cause the FPU to approximate a product of the numbers of the first floating-point format using the product or the sum of the products of the decomposed numbers in the one or more arithmetic operations.

17. The processing unit of claim 16, wherein the number of terms is statically or dynamically determined based on the accuracy demand.

18. The computing system of claim 12, wherein the first floating-point format has a first number of exponent bits, and the second floating-point format has a second number of exponent bits that is different from the first number of exponent bits.

19. The computing system of claim 12, wherein the first floating-point format and the second floating-point format have a same number of exponent bits.

20. The computing system of claim 12, wherein the first floating-point format includes at least three times as many significand bits as the second floating-point format, wherein each of the numbers of the first floating-point format is decomposable into three numbers of the second floating-point format.

21. A method of floating-point arithmetic operation approximation, comprising:
performing, by a controller of a processing unit, number decomposition on numbers of a first floating-point format to represent each of the numbers as a plurality of decomposed numbers of a second floating-point format, the second floating-point format having fewer significand bits than the first floating-point format,
performing one or more arithmetic operations using the decomposed numbers as dynamically determined based on accuracy demand, and
storing results of the one or more arithmetic operations in a memory unit in the second floating-point format.

22. The method of claim 21, further comprising:
approximating a sum of the first number and the second number of the first floating-point format by determining a sum of at least two of the decomposed numbers of the second floating-point format.

23. The method of claim 22, wherein the at least two of the decomposed numbers are determined based on significance of exponent values of the decomposed numbers.

24. The method of claim 21, further comprising:
determining a number of terms to calculate for approximating a product of the first number and the second number of the first floating-point format,
calculating one or more terms according to the determined number of terms, each term comprising either a product of the decomposed numbers of the second floating-point format or a sum of a plurality of products of the decomposed numbers of the second floating-point format, and
approximating a product of the numbers of the first floating-point format using the product or the sum of the products of the decomposed numbers in the one or more arithmetic operations.

25. The method of claim 24, wherein the number of terms is statically or dynamically determined based on the accuracy demand.
